(19) United States
(12) Patent Application Publication
(10) Pub. No.: US 2020/0077603 A1
(43) Pub. Date: Mar. 12, 2020

(54) VEHICLE WITH UNDER-BODY BLOWER

(71) Applicant: Green Industry Innovators, L.L.C., Louisville, OH (US)

(72) Inventors: Steffon Hoppel, Louisville, OH (US); Todd Pugh, Louisville, OH (US)

(21) Appl. No.: 16/194,554

(22) Filed: Nov. 19, 2018

Related U.S. Application Data
(60) Provisional application No. 62/728,461, filed on Sep. 7, 2018.

(51) Int. Cl. A01G 20/47; A01D 42/06; A01D 34/82

(52) U.S. Cl. CPC A01G 20/47; A47L 9/08; A01D 34/82; A01D 42/06

(57) ABSTRACT

A blower deck, a retrofit blower deck kit, and a vehicle incorporating the blower deck or the retrofit blower deck kit. The vehicle is a landscaping vehicle such as a tractor or a mower. The blower deck may be engaged with the vehicle frame and in a position under the body of the vehicle. The blower deck may be engaged with the vehicle frame in place of a mower deck. In other instances the blower deck may be attached to a portion of the frame so that the blower deck is located in front of the vehicle body. The retrofit blower deck kit may be utilized to convert the vehicle's mower deck to a blower deck. The retrofit kit includes a base plate that is engaged below a bottom edge of the mower deck's side wall and one or more adapters that convert the mower's cutter blade(s) to blower blade(s).

### CROSS REFERENCE TO RELATED APPLICATIONS

This application claims the benefit of U.S. Provisional Patent Application Ser. No. 62/728,461, filed Sep. 7, 2018; the entire specification of which is incorporated herein by reference.

### BACKGROUND

### Technical Field

This disclosure relates generally to landscaping equipment. More particularly, this disclosure relates to blower equipment for moving yard debris utilizing air. Specifically, this disclosure relates to a vehicle such as a tractor or mower, particularly a ride-on tractor or ride-on mower, and to a blower deck or a retrofit blower deck kit that is engageable under the body of the vehicle and is used to blow air to move yard debris from one location to another while the vehicle is stationary or is driven across a surface.

### Background Information

Landscapers frequently use blowers to direct a stream of air toward yard debris, such as fallen leaves, to move the yard debris from one location to another. Typically, these blower devices are of a type that is handheld and have a nozzle that the landscaper can manipulate in order to cause the stream of air from the device to move in a particular direction. In many instances the blower devices will have a backpack-type component that the operator will wear. A hose attachment is engaged with the backpack-type component. The backpack-type component includes a motor that sucks air into the device and blows it out of the hose attachment. One of the issues with these devices is that if a large area has to be cleared of yard debris, then handheld devices, even those that include backpack-type components, tend to become very tiring to use.

A number of machines have been developed that are stand-on, ride-on or walk behind machines that are able to blow air. The Hurricane Z3 or X3 sold by Hurricane Power of Muskegon Heights, Mich., USA, or the Ventrac Turbine Blower ET200 or KA160 Leaf Blower sold by Venture Products Inc. of Orrville Ohio are such machines. The Hurricane X3, for example, is a dedicated blower machine (i.e., does not perform other landscaping tasks) that is a stand-on vehicle that has a blower mounted on its front end. The blower can direct air to the left side, to the right side or in front of the vehicle. Hurricane Power also makes an X3 blower attachment that can be engaged in front of a walk-behind mower. The Ventrac Turbine Blower ET200 and KA160 are blower attachments that are mounted on a front end of a tractor or mower and are selectively able to blow air to the left side, to the right side or in front of the vehicle.

### SUMMARY

There is still a need in the art for improved landscaping blower equipment.

The retrofit blower deck kit, dedicated blower deck, and vehicle that includes an under-body blower deck that are disclosed herein provide advantages over previously known equipment. The retrofit blower deck disclosed herein is selectively engageable with a tractor or mower and converts the mower deck on that vehicle to a blower. A dedicated blower deck in accordance with the present disclosure may be engaged with a tractor, a mower or other landscaping vehicle in place of a mower deck or other under-body mounted equipment or front-mounted equipment. The landscaping vehicle in accordance with the present disclosure includes an under-body mounted blower deck. In each instance, the retrofit blower deck, the dedicated blower deck, or the landscaping vehicle incorporating the blower deck or retrofit blower deck can be utilized to move yard debris while stationary or while moving. Air can be drawn into the blower deck from one side and can be expelled from the other side thereof. The speed of the air is increased as air moves from the intake to the outlet. Various attachments can be engaged with the retrofit blower deck kit or with the dedicated blower deck, including a deflector element and a hose attachment.

In one aspect, the present disclosure may provide a retrofit blower deck for use with a landscaping vehicle comprising a mower deck engaged with a frame of a landscaping vehicle, wherein the mower deck comprises a first wall that is engaged with the frame; a side wall that extends downwardly from the first wall; an interior cavity defined by the first wall and the side wall; one or more rotatable members extending downwardly from the first wall and into the interior cavity; and a base plate that is securable to the mower deck; wherein said base plate is positioned opposite the first wall and closes off access to the interior cavity; an air intake provided in the mower deck or the base plate or between the mower deck and the base plate; said air intake being in fluid communication with the interior cavity; and an air outlet provided in the mower deck or the base plate or between the mower deck and the base plate; said air outlet being placed in fluid communication with the interior cavity and being located a spaced distance away from the air intake.

In another aspect, the present disclosure may provide a dedicated blower deck for use with a landscaping vehicle, said blower deck comprising a first wall adapted to be engaged with a frame of the landscaping vehicle; a second wall spaced a distance from the first wall; a side wall extending between the first and second walls; a cavity bounded and defined by the first wall, the second wall and the side wall; one or more rotatable members extending from the first wall into the cavity; said one or more rotatable members being adapted to be driven by a motor of the landscaping vehicle; an air intake defined in one of the first wall, the second wall or the side wall; and an air outlet defined in one of the first wall, the second wall or the side wall a spaced distance away from the air intake. In one example, the air outlet is defined in the side wall in a region opposite to the location of the air intake.

In another aspect, the present disclosure may provide a blower conversion kit for a mower, wherein the mower has a mower deck including an first wall and a side wall extending downwardly from the first wall; and at least one cutter blade extending downwardly from the first wall and into a cavity that is bounded and defined by the first wall and the side wall; wherein the kit comprises a base plate that is substantially complementary in shape to a bottom edge of the side wall of the mower deck; and at least one adjuster configured to be engageable with at least one cutter blade.

In yet another aspect, the present disclosure may provide a method of engaging and utilizing a blower deck on a landscaping vehicle comprising providing a blower deck including a first wall, a second wall spaced a distance from the first wall; a side wall extending between the first and second walls; a cavity bounded and defined by the first wall, the second wall and the side wall; one or more rotatable members extending from the first wall into the cavity; an air intake defined in one of the first wall, the second wall or the side wall; and an air outlet defined in one of the first wall, the second wall or the side wall a spaced distance from the air intake; securing the first wall to the landscaping vehicle; and operatively engaging the one or more rotatable members with a motor of the landscaping vehicle.

In a further aspect, the present disclosure may provide a method of removing yard debris comprising providing a mower that includes a mower deck and at least one blade that is rotatable in a first mode to cut grass; selectively engaging a base plate below the mower deck such that a cavity is defined between the mower deck and an interior surface of the base plate and such that the at least one blade is located within the cavity; providing an air intake into the cavity; providing an air outlet from the cavity; rotating the at least one blade within the cavity; drawing air into the cavity through the air intake as the at least one blade rotates; discharging air out of the cavity through the air outlet as the at least one blade rotates.

In another aspect, the present disclosure may provide a method of removing yard debris comprising disengaging a mower deck (or another landscaping attachment) from a frame of a landscaping vehicle; providing a blower deck comprising a first wall, a second wall spaced from the first wall; and a side wall extending between the first and second walls; and an air intake and air outlet in fluid communication with a cavity bounded and defined by the first wall, the second wall and the side wall; engaging one or more rotatable members on the first wall of the blower deck; wherein each of the one or more rotatable members is located within the cavity; engaging the blower deck on the frame of the landscaping vehicle; activating the one or more rotatable members; drawing air into the cavity through the air intake as the one or more rotatable members rotates; pushing air out of the cavity through the air outlet as the one or more rotatable members rotates; and directing the air pushed out of the cavity to blow yard debris from a first location proximate the mower to a second location remote from the landscaping vehicle. The blower deck may be engaged with the vehicle in the location that was previously occupied by the disengaged mower deck or the disengaged other landscaping attachment.

In a further aspect, the present disclosure may provide in combination a vehicle having a body and a plurality of wheels for moving the body across a surface; and a blower deck; wherein the blower deck comprises a first wall adapted to be engaged with a frame of the vehicle; a second wall spaced a distance from the first wall; a side wall extending between the first and second walls; a cavity bounded and defined by the first wall, the second wall and the side wall; one or more rotatable members extending from the first wall into the cavity; an air intake defined in one of the first wall, the second wall or the side wall; and an air outlet defined in one of the first wall, the second wall or the side wall a spaced distance from the air intake; and wherein the blower deck is located horizontally underneath a portion of a body of the vehicle.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top plan view of a tractor incorporating an under-body blower deck in accordance with the present disclosure and showing the blower deck being used to blow leaves;

FIG. 2 is a top, rear, right side isometric perspective view of a mower deck removed from a landscaping vehicle and showing a first embodiment blower deck retrofit kit engaged therewith by way of hook and loop fasteners;

FIG. 3 is an exploded top, rear, right side isometric perspective view of mower deck with blower deck retrofit-kit of FIG. 2;

FIG. 4 is a bottom, rear, left side isometric perspective view of the mower deck with the blower deck retrofit-kit of FIG. 2;

FIG. 4A is a bottom, rear, left side isometric perspective view of a mower deck with the blower deck retrofit-kit being engaged with the mower deck utilizing tabs and fasteners;

FIG. 5 is a bottom, rear, left side isometric perspective view of the blower deck retrofit-kit of FIG. 4 shown on its own;

FIG. 5A is a bottom, rear, left side isometric perspective view of a blower deck retrofit-kit of FIG. 4A shown on its own;

FIG. 6 is a bottom, rear, left side isometric perspective view of the mower deck of FIG. 4 shown on its own;

FIG. 7 is a bottom, rear, left side isometric perspective view of a second embodiment of a blower deck retrofit-kit that includes multiple air ducts (i.e., multiple air intakes); wherein the blower deck retrofit kit is engageable with a mower deck by way of hook and loop fasteners;

FIG. 8 is a cross section taken along line 8-8 of FIG. 2;

FIG. 9 is a bottom plan view of the mower deck shown on its own;

FIG. 10 is a top, rear, right side isometric perspective view of a mower deck with a third embodiment of a blower deck retrofit-kit engaged therewith using hook and loop;

FIG. 11 is a top, rear, right side isometric perspective view of the blower deck retrofit-kit of FIG. 10;

FIG. 12 is a cross section taken along line 12-12 of FIG. 10;

FIG. 13 is a top isometric perspective view of a single blower blade;

FIG. 14 is an exploded top isometric perspective view of mower blade with blower adapters;

FIG. 15 is a top isometric perspective view of the mower blade with blower adapters attached thereto;

FIG. 16 is a top plan view of a mower deck with a blower deck retrofit-kit engaged therewith and including a generic directional selector engaged therewith;

FIG. 17 is a top plan view of a mower deck with a blower deck retrofit-kit engaged therewith and including a generic hose attachment engaged therewith;

FIG. 18 is a top, rear, right side isometric perspective view of a first embodiment of an independent blower deck that includes impellers;

FIG. 19 is a bottom, rear, left side isometric perspective view of the blower deck of FIG. 18;

FIG. 20 is a bottom, rear, left side isometric perspective view the blower deck of FIG. 19 with the bottom wall cut-away to reveal the impellers;

FIG. 21 is a bottom, rear, left side isometric perspective view of a second embodiment of an independent blower deck that includes impellers;

FIG. 22 is a top, rear, right side isometric perspective view of a third embodiment of an independent blower deck in accordance with the present disclosure;

FIG. 23 is a top, rear, right side isometric perspective view of a fourth embodiment of an independent blower deck in accordance with the present disclosure; and

FIG. 24 is a left side elevation of the independent blower deck shown mounted in a vertical orientation to an ‘A’ frame lift of a stand-behind tractor.

Similar numbers refer to similar parts throughout the drawings.

### DETAILED DESCRIPTION

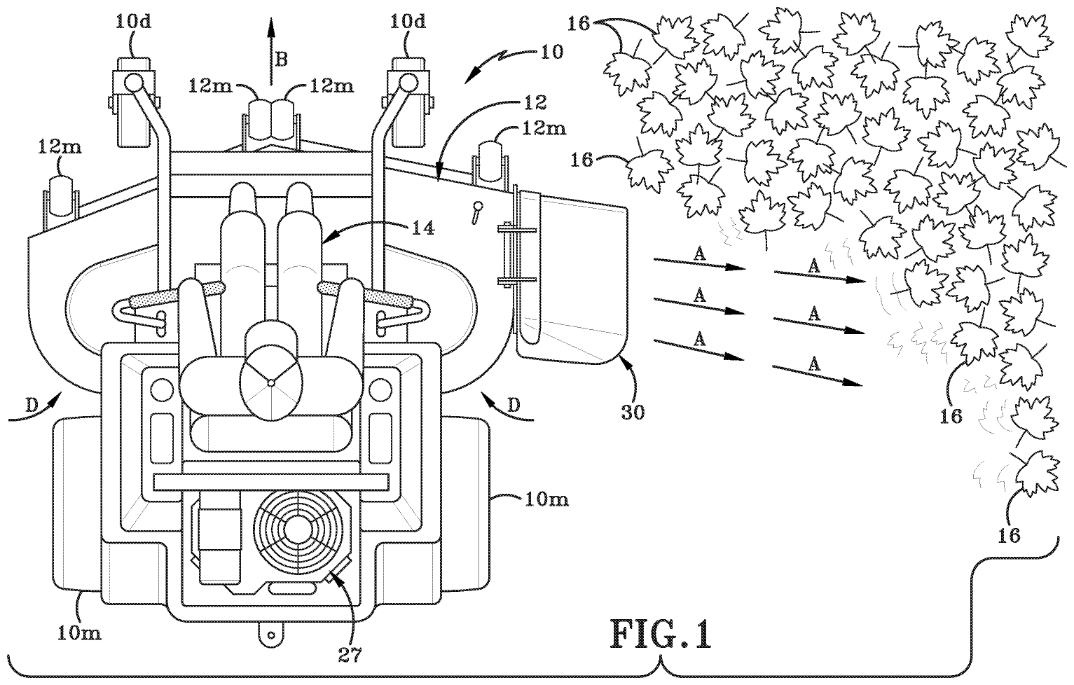

FIG. 1 shows a landscaping vehicle 10 upon which a horizontally-oriented mower deck 12 is mounted under a main part of the vehicle's body or frame. Vehicle 10 may be any type of landscaping vehicle including but not limited to a tractor or a mower, particularly, a zero-turn tractor, or a zero-turn mower. In other words, vehicle 10 may be a zero-turn vehicle. Vehicle 10 may be of a type upon which an operator 14 may be seated. Vehicle 10 may initially be a mower that is used to cut grass and may be converted to an air-moving device by utilizing the apparatus disclosed herein. In accordance with an aspect of the present disclosure, vehicle 10 may be converted to an apparatus that can blow a quantity of air outwardly therefrom by engaging a blower deck thereon. The blower deck may be utilized to blow yard debris 16, such as fallen leaves, in a desired direction. The blower deck may be utilized to blow air toward the yard debris 16 in a direction indicated by arrows “A” when vehicle 10 is stationary or when vehicle 10 moves across a lawn or across any other ground surface. A selected direction of travel of vehicle 10 across a ground surface is illustrated in FIG. 1 by the arrow “B”. It will be understood that the direction of blowing air is exemplary only and that the blower deck may be configured to blow air in a desired direction or directions.

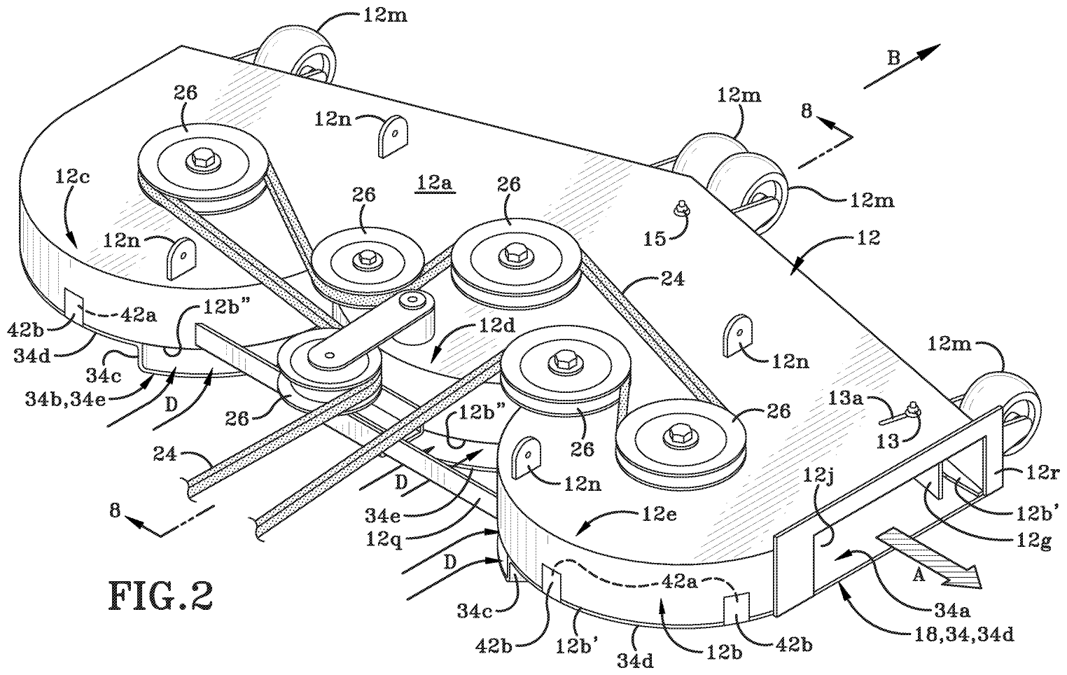

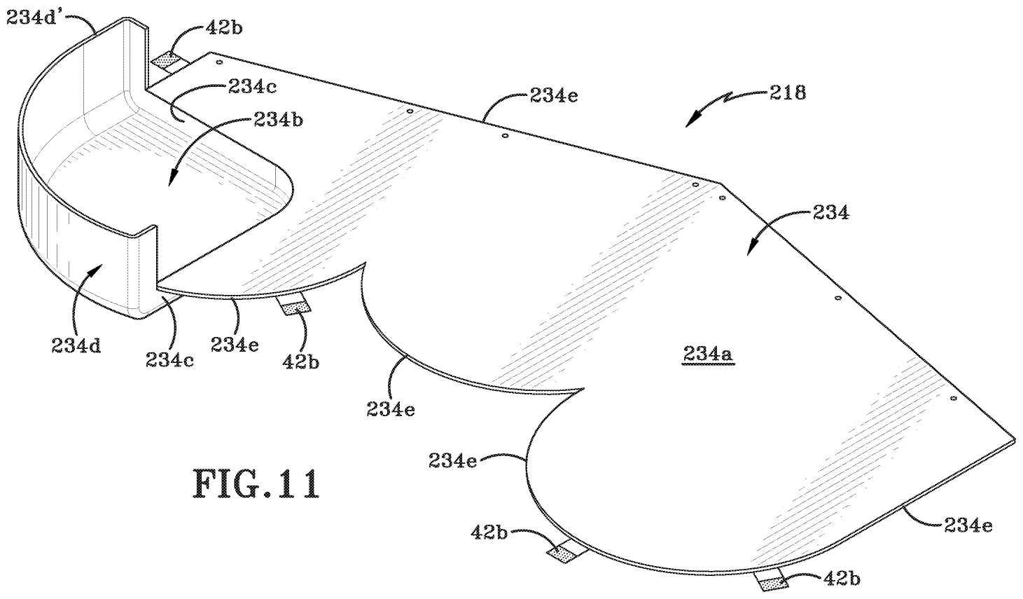

In accordance with an aspect of the present disclosure, the blower deck provided on vehicle 10 may be provided in a first example as a blower deck retrofit-kit that is selectively engageable with mower deck 12. The blower deck retrofit-kit (hereafter referred to as the “retrofit-kit”) is generally indicated by the reference number 18 and shown in FIGS. 2 to 17.

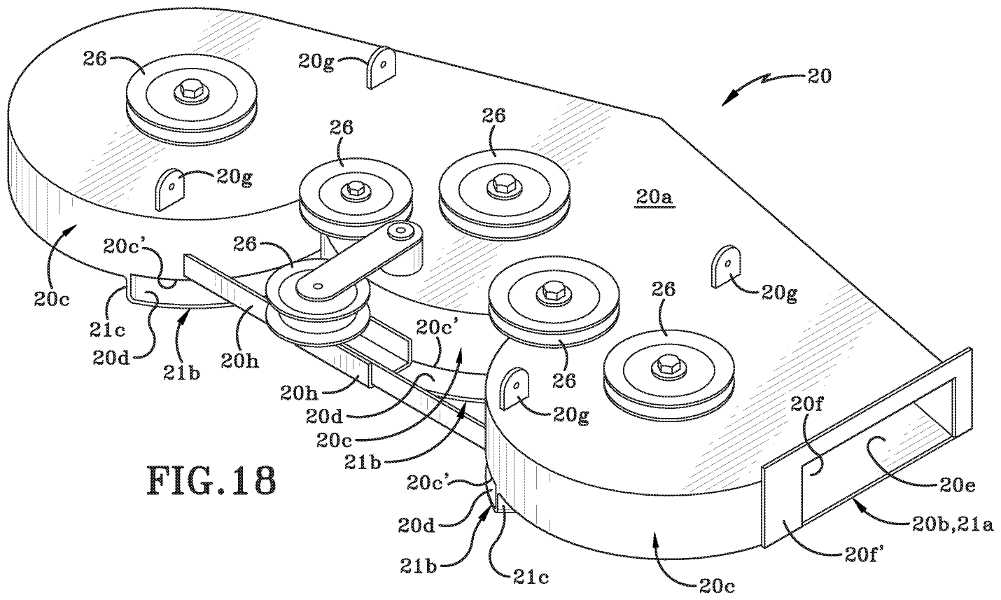

Alternatively, the blower deck may be provided as an independent blower deck that is engaged with vehicle 10 only after removal of mower deck 12 therefrom. The independent blower deck (hereafter referred to as the “deck”) is generally indicated by the reference number 20 and is shown in FIGS. 18 to 23.

In accordance with another aspect of the invention, retrofit-kit 18 may be oriented generally horizontally when engaged underneath the mower deck 12 of vehicle 10. Retrofit-kit 18 converts mower deck 12 from a device useful for cutting grass to a device useful for blowing air that is an under-body-mounted air blower on vehicle 10. As will be described later herein, engaging retrofit-kit 18 with mower deck 12 prevents vehicle 10 from performing a mowing task and, instead, vehicle 10 may only perform an air blowing task if the retrofit-kit 18/mower deck 12 combination is the only attachment engaged with vehicle 10.

In other examples, mower deck 12 may be completely disengaged and removed from vehicle 10. Deck 20 may then be engaged underneath the frame of the vehicle 10 in the place of the removed mower deck 12. In order to accomplish this, deck 20 will be oriented substantially horizontally and will be secured to the frame. It should be noted that in this instance, exactly the same components that were used to secure mower deck 12 under the body or frame of vehicle 10 may be used to secure deck 20 thereto. Deck 20 therefore takes the same position, orientation and location as the mower deck 12 had previously occupied. Engaging deck 20 in this manner prevents vehicle 10 from performing a mowing task and only allows vehicle 10 to perform an air blowing task using deck 20 as an independent blower to move yard debris such as leaves 16.

Locating retrofit-kit 18 or deck 20 in an under-body position on vehicle 10 tends to keep the orientation of the retrofit-kit 18 or deck 20 in a substantially constant position and orientation relative to frame 10.

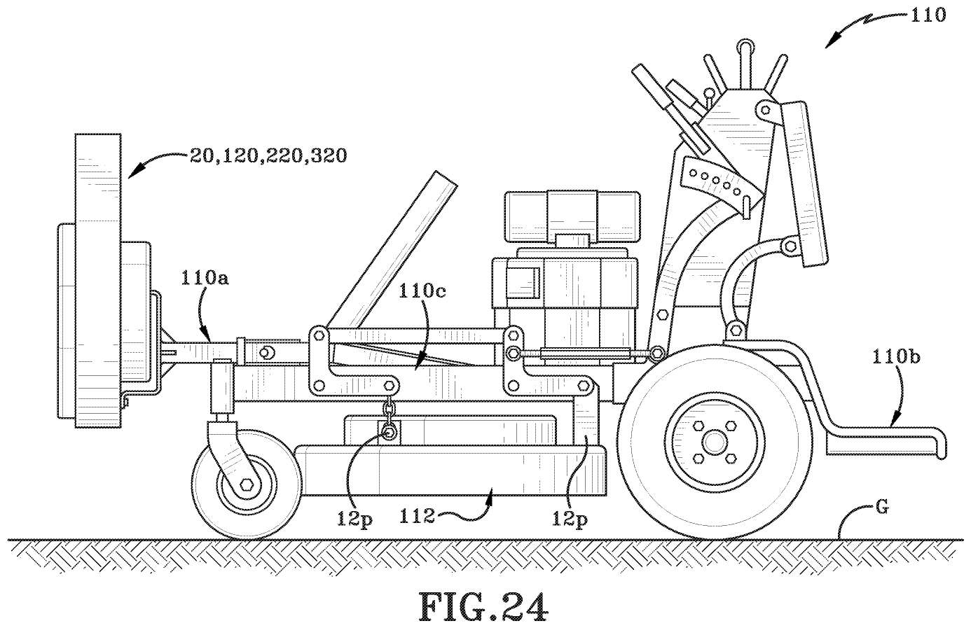

In another example, such as is shown in FIG. 24, deck 20, for instance, may be vertically oriented and secured to a front end of a hydraulically operable attachment member 110a of a landscaping vehicle 110. Landscaping vehicle 110 as illustrated in FIG. 24 differs from vehicle 10 shown in FIG. 1 in that vehicle is a stand-on tractor or stand-on mower. In other words, vehicle 110 includes a platform 110b upon which an operator will stand. Vehicle 110 may be a zero-turn tractor or mower. Vehicle 110 includes a horizontally-oriented mower deck 112 that is located under the vehicle body or frame 110c. The mower deck 112 may be used to mow grass. Deck 20 may be oriented vertically, i.e., substantially at right angles to mower deck 112 and may be used to blow air. The mower deck 112 and deck 20 may be independently operated to perform two separate landscaping tasks, respectively, i.e., mowing and blowing air. These separate landscaping tasks may, in some instances, be performed substantially simultaneously. FIG. 24 shows mower deck 112 is an under-body component but deck 20 is not an under-body component. As attachment member 110a is raised, seconded, advanced, or retracted, the position and/or orientation of deck 20 relative to the vehicle frame 110c and the ground surface “G” may change.

In yet other instances (not illustrated herein), the vehicle upon which retrofit-kit 18 or deck 20 may be engaged may be a walk-behind mower.

It will be understood that retrofit-kit 18 and deck 20 may be engaged with any of a number of different landscaping vehicles and the particular vehicles 10 and 110 illustrated herein are by way of example only and should not be considered to limit where and how retrofit-kit and deck 20 are engaged and utilized.

FIG. 2 illustrates mower deck 12 shown on its own (i.e., detached from vehicle 10 (or 110)). It should be understood that the particular shape, size and configuration of mower deck 12 is an example of a mower deck 12 that may be converted to an air blower by engaging retrofit-kit 18 thereto. The exact shape of retrofit-kit 18 is selected to be complementary to the specific mower deck 12 with which retrofit-kit 18 is designed to be engaged.

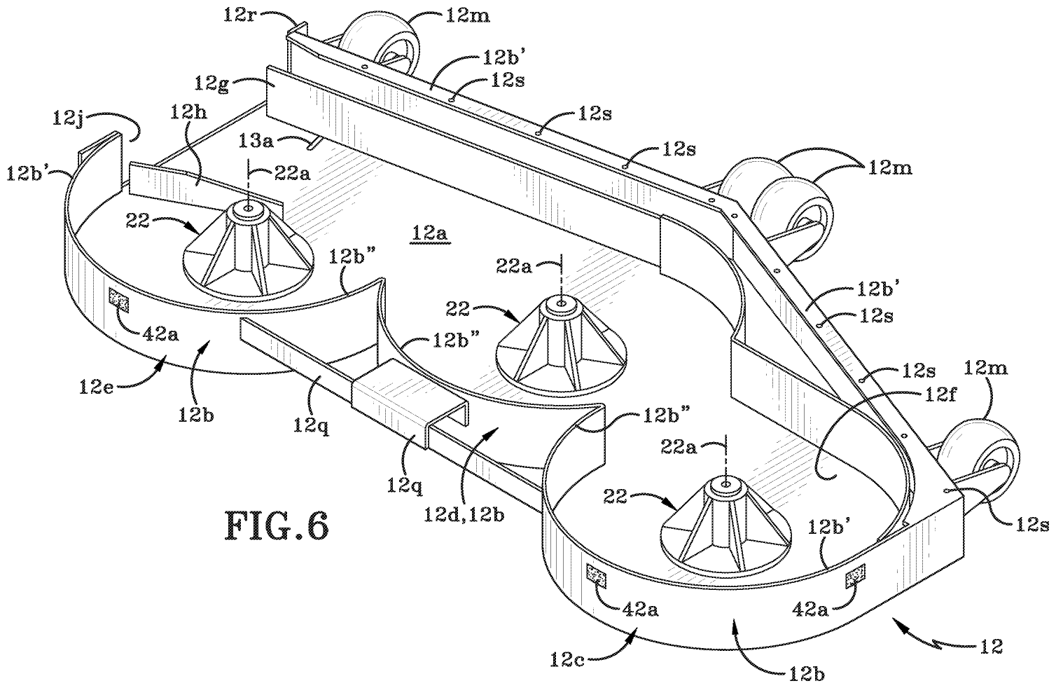

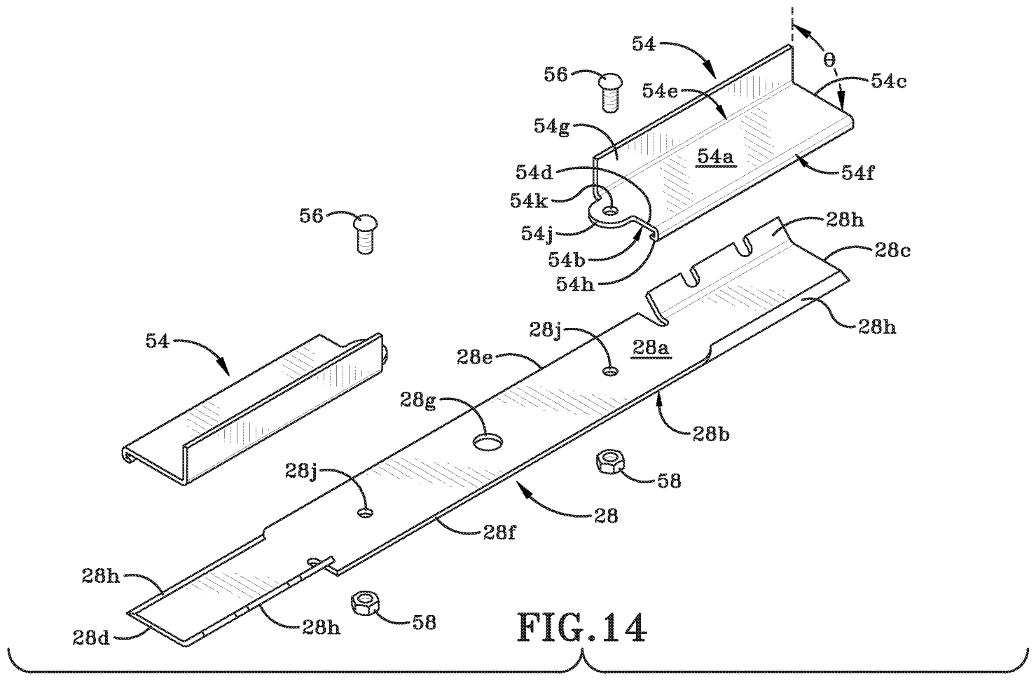

The exemplary mower deck 12, as shown in FIG. 2, includes a first wall 12a and a peripheral wall 12b that extends downwardly from a perimeter of first wall 12a. It should be noted that first wall 12a is an upper wall of the mower deck 12 that will be operatively engaged with a frame of vehicle 10. In particular, first wall 12a will be secured to the frame in a position below a body of vehicle 10. The first wall 12a and peripheral wall 12b are shaped to form three generally semi-circular lobes 12c, 12d, and 12e. Lobes 12c, 12d, 12e form the trailing edge of mower deck 12 (i.e., rear region of mower deck 12 when vehicle 10 moves in direction “B” of FIG. 1). First wall 12a and peripheral wall 12b bound and define a cavity 12f (FIG. 6). Three rotatable mountings 22 extend outwardly from an interior surface of first wall 12a. Mountings 22 are operatively engaged with and driven by the drive belt 24 and various pulleys 26 illustrated in FIG. 2. Drive belt 24 is operatively engaged with and driven by the mower's engine 27 (FIG. 1). As drive belt 24 is driven, mountings 22 are rotated about their respective axes 22a. (Each axis 22a is oriented perpendicular to first wall 12a.) FIG. 14 shows one or more cutting implements engaged with mountings 22. In particular, a cutter blade 28 is engaged with each mounting 22. As mountings 22 rotate about their respective axis 22a, the cutter blade 28 also be rotated about the axis 22a. Mower deck 12 includes three lobes 12c, 12d, 12e; i.e., one for each of the mountings 22 and each mounting 22 will secure a cutter blade 28 to mower deck 12. If mower deck 12 is differently configured there may be only one mounting and an associated single cutter blade; or two mountings and two cutter blades or, in some instances, even more than three mountings 22 and more than three cutter blades 28.

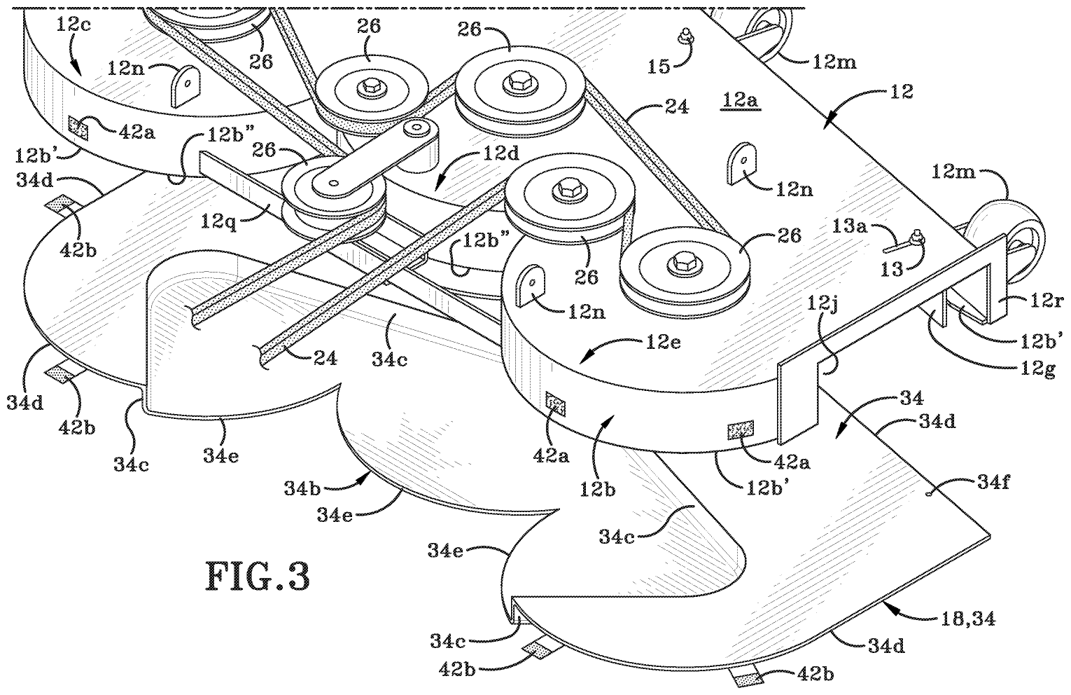

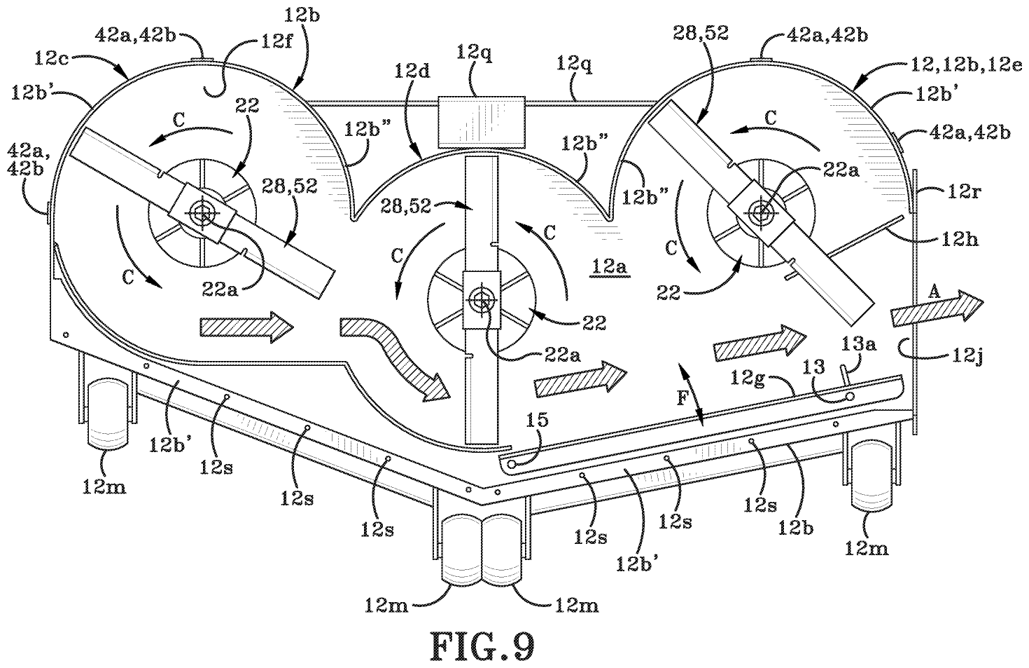

Referring to FIGS. 6, 3 and 9, mower deck 12 may also include interior walls 12g, 12h that are shaped and located to funnel cut grass through a chute 12j that has an opening on a side region of peripheral wall 12b. A portion of wall 12g is able to be pivoted by loosening the nut on bolt 13 (FIG. 2 or 9) and sliding bolt 13 along slot 13a. The sliding motion causes wall 12g to pivot about bolt 15. When wall 12g is in the desired orientation then the nut on bolt 13 is fastened once again. The pivoting motion is indicated by arrow “F” in FIG. 2.

Mower deck 12 may further include a frame upon which one or more sets of wheels 12m are mounted. Wheels 12m contact the ground surface when vehicle 10 is in operation. Wheels 12m aid in supporting the leading edge of mower deck 12 (i.e., the front region of mower deck 12 when vehicle 10 is moving in the direction “B” shown in FIG. 1). Wheels 12m aid in support the leading edge a distance vertically above the ground surface. Wheels 12m are not part of the wheels 10d (FIG. 1) of vehicle 10 that move vehicle 10 across the ground surface.

Mower deck 12 may be securable beneath a portion of the vehicle frame by a mounting assembly. To this end, a plurality of mounting brackets 12n (FIG. 2) may extend upwardly from exterior surface of first wall 12a. Mounting brackets 12n and similar brackets provided on the frame of vehicle 10 in conjunction with a plurality of bolts, washers and nuts may form the mounting assembly that secures mower deck 12 under the body of vehicle 10. FIG. 24 shows a second type of mounting assembly for securing mower deck 112 to frame 110c. In this instance, mounting assembly takes the form of a linkage assembly 12p may be utilized to secure mower deck 112 to frame 110c. Linkage assembly 12p may be adjusted to vary the height of cutter blades 28 relative to the grass that extends upwardly from ground surface “G”. Cutter blades 28 extend into a space located beneath a second surface of first wall 12a. Each cutter blade 28 is rotatable about axis 22a and is provided with one or more cutting edges that will sever blades of grass when the rotating cutting blade 28 contacts the same.

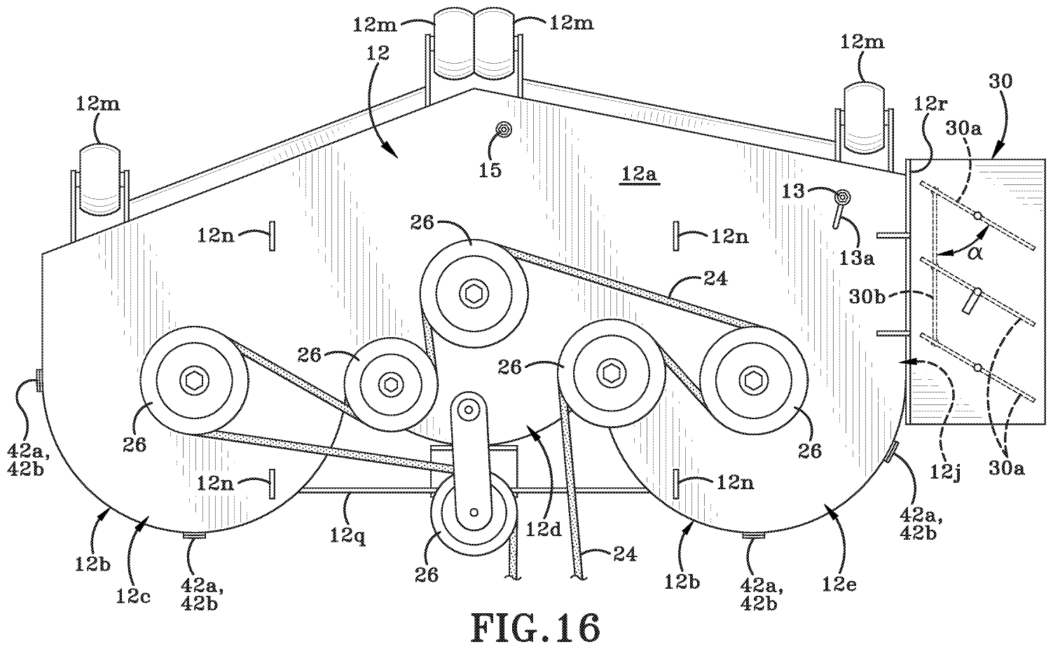

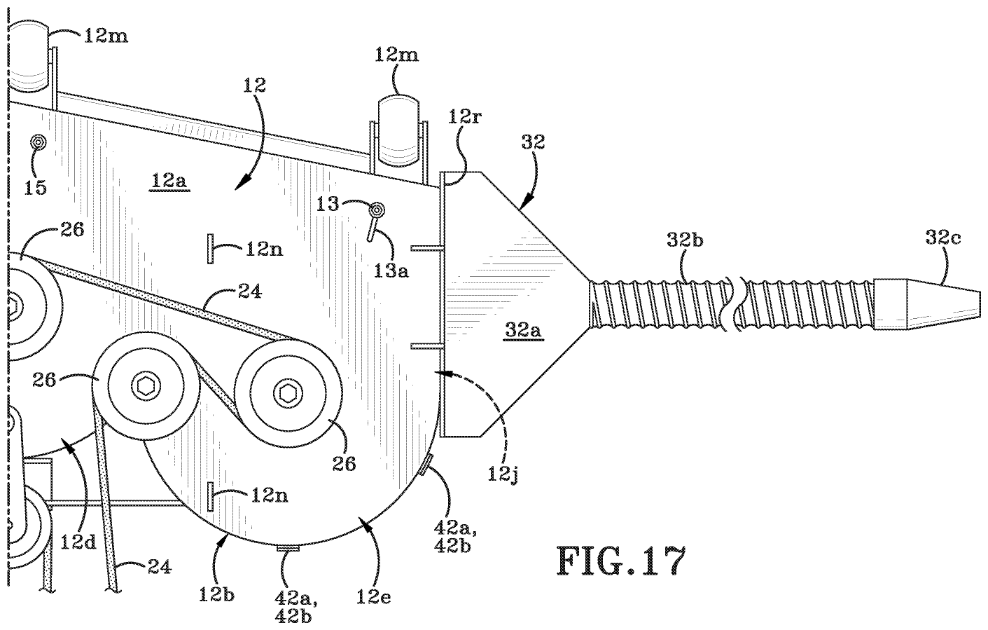

One or more braces 12q (FIG. 2) may be provided on mower deck 12 to give the mower deck 12 improved strength and stability. A chute frame 12r may be provided around the opening to chute 12j. Chute frame 12r increases the strength and stability of mower deck 12 about the mouth of chute 12j but also provides a method of seating a mower bag (not shown) or a deflector element 30 such as is illustrated in FIGS. 1 and 16, or a hose attachment 32 (FIG. 17). Deflector element 30 or hose attachment 32 may be engaged with mower deck 12 adjacent chute 12j.

In accordance with an aspect of the present disclosure, retrofit-kit 18 may be engaged with mower deck 12 to change the function of mower deck 12 from a mowing function to an air-blowing function.

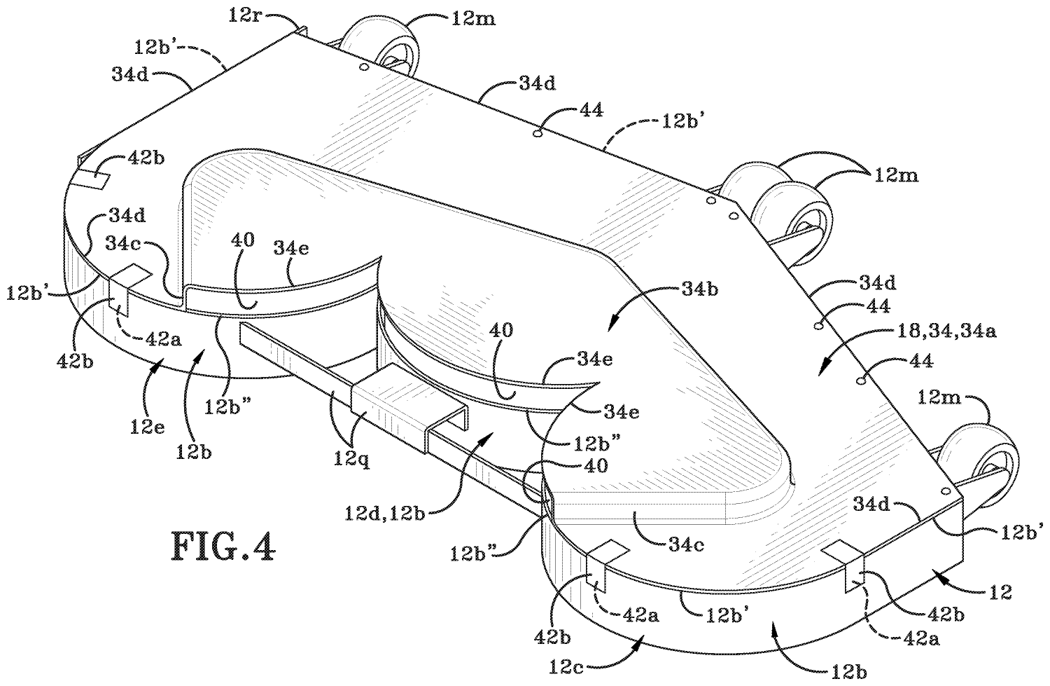

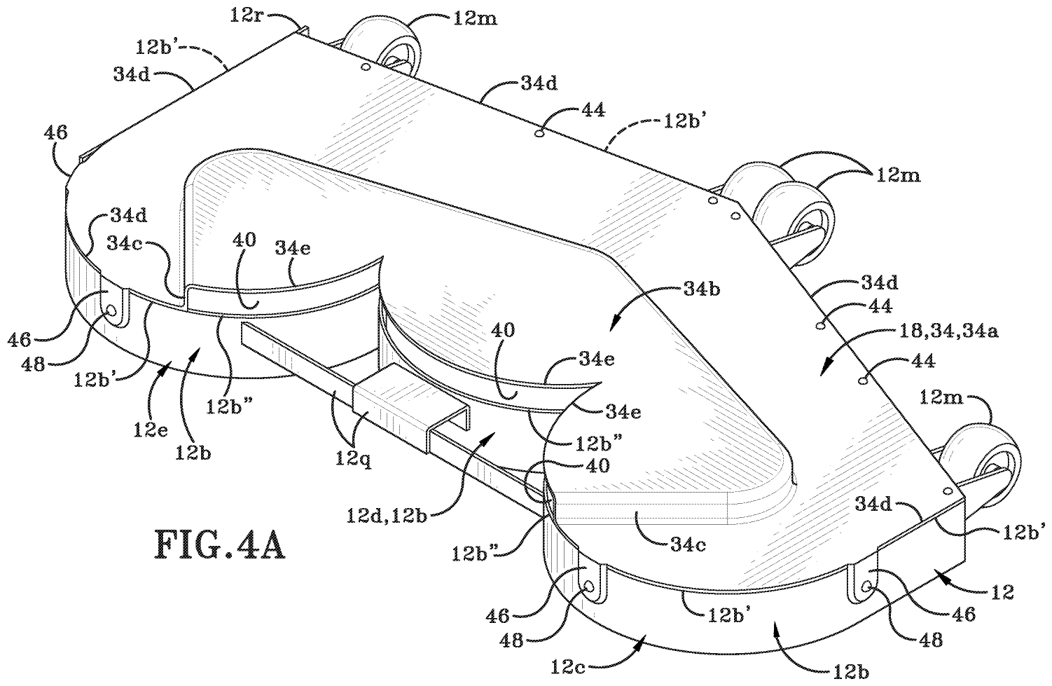

Retrofit-kit 18 comprises a base plate 34 comprising a first region 34a that is disposed in a first plane and a second region 34b that is recessed relative to first region 34a. Second region 34b is disposed in a second plane that may be substantially parallel to the first plane and spaced a distance vertically below the first plane when retrofit-kit 18 is engaged with mower deck 12 and mounted in the orientation shown in FIG. 2. A transition wall 34c extends between first region 34a and second region 34b. First region 34a has a peripheral outer edge 34d and second region 34b has a scalloped peripheral outer edge 34e. When retrofit-kit 18 is engaged on mower deck (as shown in FIG. 2), the peripheral outer edge 34d of first region 34a is aligned with and placed in contact with a first portion 12b′ of a flange peripheral wall 12b of mower deck 12. The scalloped peripheral outer edge 34e of second region 34b is aligned with a second portion 12b″ (FIG. 2) of the first, second and third lobes 12c, 12d, and 12e of mower deck 12. Outer edge 34e of second region 34b is not placed in contact with the second portion 12b″ of mower deck 12 but is, instead, spaced a distance vertically away therefrom. As a result, an opening is defined between the first, second and third lobes 12c, 12d, and 12e of mower deck 12 and the scalloped peripheral outer edge 34e of retrofit-kit. This opening is identified by the reference number 40 in FIG. 4. Base plate 34 of retrofit-kit 18 forms a bottom wall to cavity 12f defined by mower deck 12. Opening 40 is an air intake (or an air duct) that is placed in fluid communication with the interior cavity 12f of mower deck 12. The opening to chute 12j is also placed in fluid communication with cavity 12f and thereby with opening 40. Chute 12j is an air outlet that is placed in fluid communication with cavity 12f and thereby with the air intake (i.e., opening 40). As is evident from FIG. 4, opening 40 is formed in a generally central region of the trailing edge of mower deck 12.

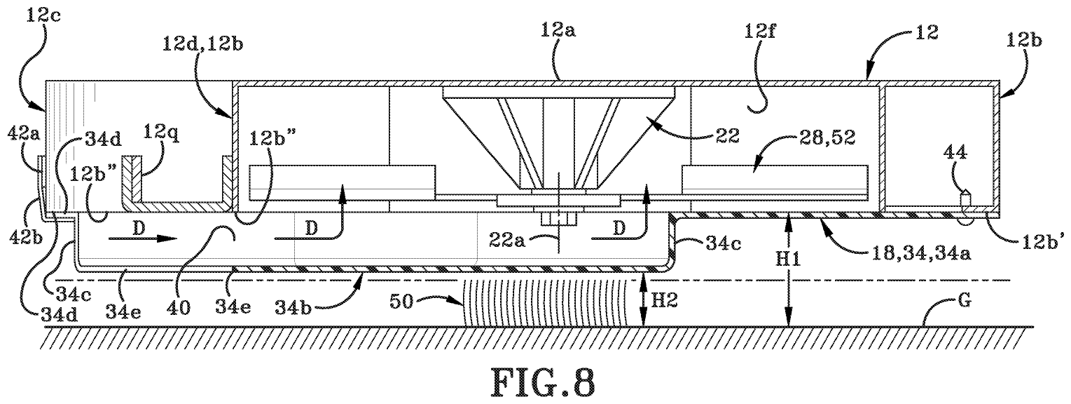

Base plate 34 may be comprised in a first example out of a substantially flexible material. This flexible material may aid in the base plate 34 hugging the ground as the vehicle 10 moves across the surface. Base plate 34 may be a plastic blow-molded member. In a second example, base plate 34 may be comprised of a substantially rigid material. Base plate 34 may, for example, be fabricated from stamped steel, aluminum, plastic or a combination of one or more of steel, aluminum, and plastic. In either instance, whether base plate 34 is flexible or rigid, the overall height of the under-body blower deck above the ground “G” is reduced relative to the height of the mower deck 12 from the ground “G”. FIG. 8 shows the distance between the lowermost end 12b′ of the mower deck 12 and the ground “G” is the height “H1”. The distance between the lowermost region 34b of blower deck 18 and the ground “G” is the height “H2”. FIG. 8 shows that height “H2” is smaller than height “H1”. The decreased distance between blower deck 18 and ground “G” helps to create a somewhat tight seal between vehicle 10 and the ground “G” which helps vehicle 10 to blow yard debris 16 more effectively away from vehicle 10.

FIGS. 2 to 4 show a first fastener assembly for releasably securing retrofit-kit 18 to mower deck 12. The fastener assembly comprises a plurality of hook and loop fastener strips 42a, 42b. The hook strips 42a may be provided on mower deck 12 and the loop strips 42b may be provided on retrofit-kit 18 or vice versa. Alternatively, some of the hook strips 42a may be provided on the mower deck 12 and the rest of the hook strips 42a may be provided on retrofit-kit 18; and some of the mating loop strips 42b may be provided on mower deck 12 while the rest of the loop strips 42b are provided on retrofit-kit 18. Hook strips 42a and loop strips 42b are placed in complementary locations on mower deck 12 and retrofit-kit 18 so that they may be readily engaged with each other and thereby secure mower deck and retrofit-kit 18 to each other.

In addition to hook and loop fastener strips 42, 42b, base plate 34 may be provided with a plurality of holes 34f (FIG. 3) that are provided at spaced intervals along a portion of the base plate 34 that will align with apertures 12s (FIG. 6) defined in a flange 12b′ of the leading edge of mower deck 12. Fasteners 44 are received through the aligned holes 34f, 12s to secure retrofit-kit 18 and mower deck 12 together.

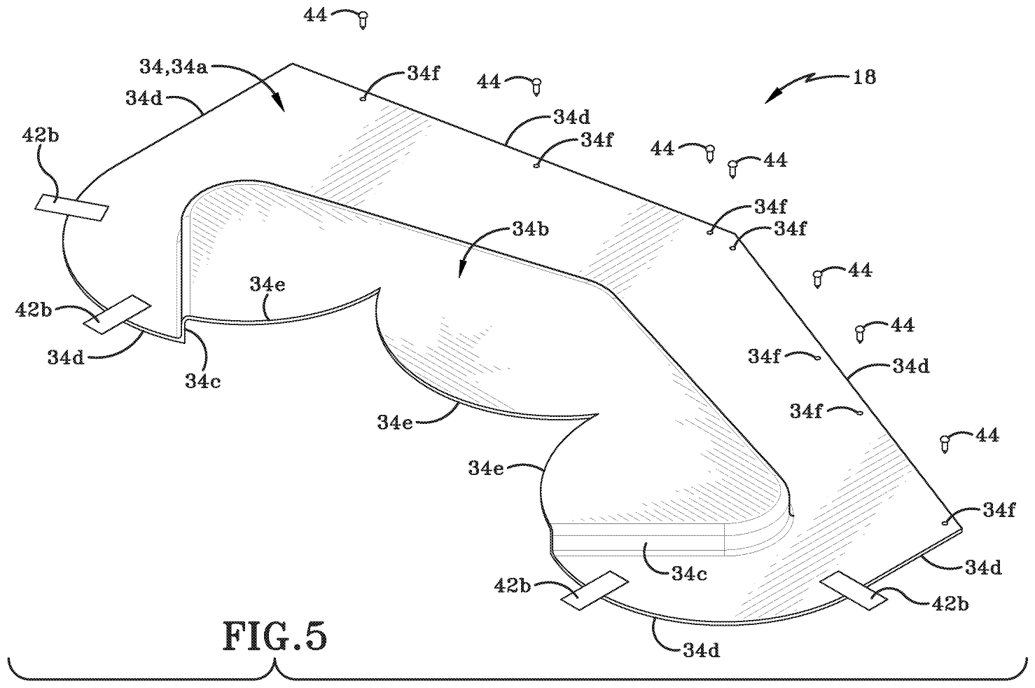

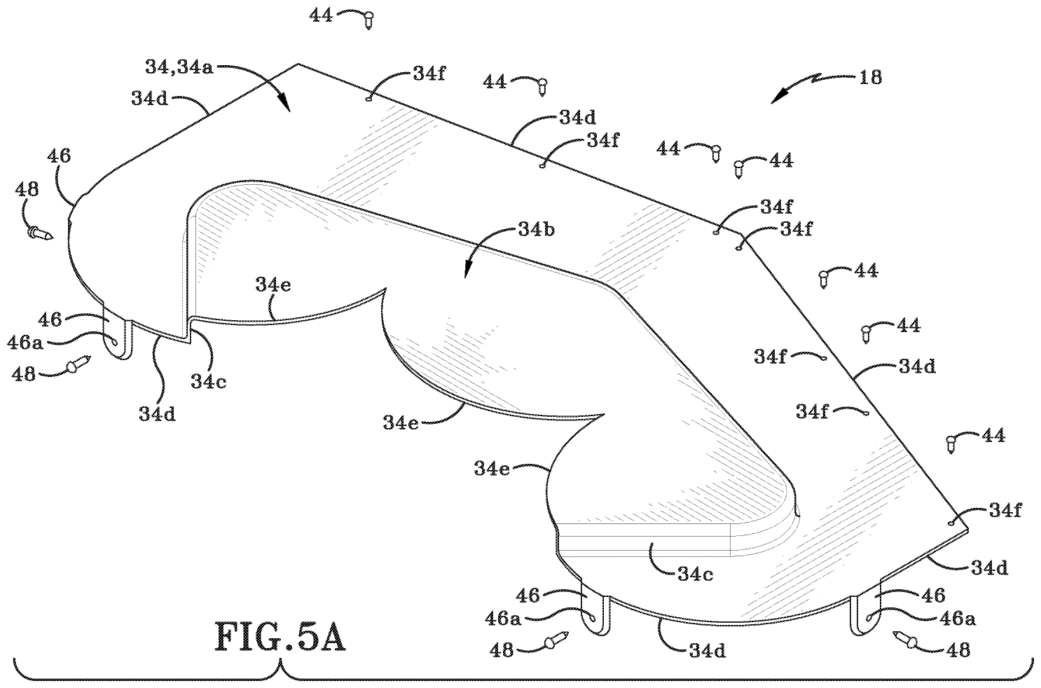

FIGS. 4A and 5A show a different fastener assembly for releasably securing retrofit-kit 18 and mower deck 12 together. In this example, hook and loop fasteners 42a, 42b are replaced by tabs 46 that are provided on retrofit-kit 18 and/or mower deck 12. As illustrated in these two figures the tabs 46 are provided on retrofit-kit 18 but could, instead be provided on mower deck 12; or some of the tabs 46 may be provided on retrofit-kit 18 and others on mower deck 12. Each tab 46 defines an aperture 46a (FIG. 5A therein. A fastener 48 is inserted through each aperture 46a and is screwed into an aligned holes defined in the mower deck 12 when tabs 46 are provided on retrofit-kit 18. If tabs 46 are provided on mower deck 12 then the fasteners 48 will be screwed into aligned holes defined in retrofit-kit 18.

It will be understood that the number and placement of hook and loop fasteners strips 42a, 46b or tabs 46 may be varied in accordance with the specific shape and size of mower deck 12 and thereby of retrofit-kit 18. The number and placement of the fastener assemblies in the attached figures is provided by way of example only. It will also be understood that other fastener assemblies may be utilized instead of those disclosed in the attached figures.

The retrofit-kit blower deck formed by mower deck 12 and base plate 34 has a first wall (i.e., wall 12a), a bottom wall (i.e., base plate 34), and a side wall (i.e., peripheral wall 12b) extending between the top and bottom walls. Opening 40 (i.e., the air intake) is illustrated as being defined in a portion of the side wall of the retrofit-kit blower deck and the chute 12j (i.e., the air outlet) is also defined in a portion of the side wall of the retrofit-kit blower deck but the chute 12j is located a distance away from the opening 40. It will be understood that in other exemplary embodiments of the retrofit-kit blower deck, the opening 40 may be defined in other locations such as first wall 12a or bottom wall 34. It will further be understood that chute 12j may be defined in other locations such as first wall 12a or bottom wall 34.

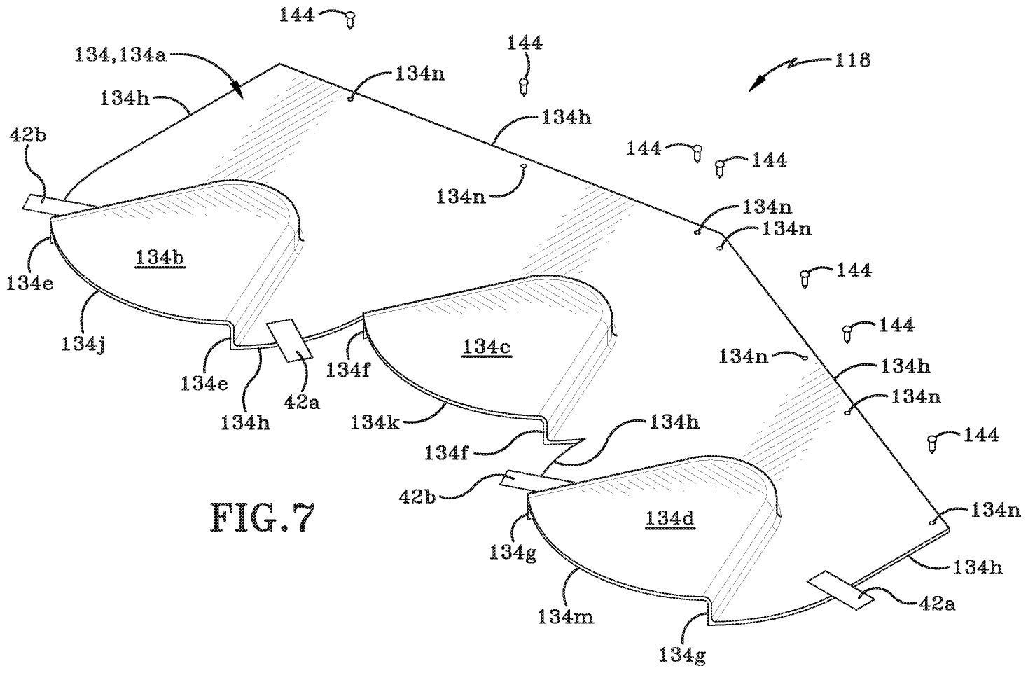

FIG. 7 shows a second embodiment of base plate 134 that may be provided as retrofit kit 118. Base plate 134 comprises a first region 134a that is disposed in a first plane and a second region 134b, third region 134c, and fourth region 134d that are recessed relative to first region 134a. Second third, and fourth regions 134b, 134c, 134d are disposed in a second plane that may be substantially parallel to the first plane and spaced a distance vertically below the first plane when retrofit-kit 18 is engaged with mower deck 12. A transition wall 134e extends between first region 134a and second region 134b. A transition wall 134f extends between first region 134a and third region 134c and a transition wall 134g extends between first region 134a and fourth region 134d. First region 134a has a peripheral outer edge 134h; second region 134b has an arcuate peripheral outer edge 134j; third region 134c has an arcuate peripheral outer edge 134k and fourth region has an arcuate peripheral outer edge 134m.

When this second embodiment retrofit-kit 118 is engaged on mower deck (in a similar manner to what is shown in FIG. 2), the peripheral outer edge 134d of first region 34a is aligned with and placed in contact with flange 12b′ of peripheral wall 12b of mower deck 12. The arcuate peripheral outer edges 134j, 134k and 134m of second region 134b, third region 134c, and fourth region 134e are aligned with a second portion 12b″ (FIG. 2) of the first, second and third lobes 12c, 12d, and 12e of mower deck 12. Outer edges 134j, 134k, 134m are not placed in contact with the second portion 12b″ of mower deck 12 but are, instead, spaced a distance vertically away therefrom. As a result, a first opening is defined between the second region 134b and the third lobe 12e, a second opening is defined between the third region 134c, and second lobe 12d, and a third opening is defined between the fourth region 134d and first lobe 12c. The first, second and third openings are placed in fluid communication with the cavity 12f defined by the mower deck 12 in a similar manner to the opening 40 of retrofit-kit 18. The opening to chute 12j is also placed in fluid communication with cavity 12f and thereby with the first, second and third openings defined between retrofit-kit 118 and mower 12. The first, second and third openings are located along the trailing edge of mower deck 12.

FIG. 7 shows that retrofit-kit 118 includes hook and loop type fastener strips 42a, 42b that may be used to secure retrofit-kit 118 to complementary hook and loop fastener strips 42a, 42b on mower deck 12. It will be understood that tabs similar to tabs 46 may be used instead of hook and loop fastener strips 42a, 42b or any other type of fastener assembly may be used for this purpose. As with retrofit-kit 18, retrofit-kit 118 may define a plurality of holes 134n proximate a leading edge thereof and fasteners 144 may be utilized to secure retrofit kit 118 to mower deck 12.

FIGS. 2 and 8 show how the retrofit-kit 18 is used in conjunction with mower deck 12. When retrofit-kit 18 is secured to mower deck 12 then the cutter blades 28 of vehicle 10 can no longer be used to cut grass 50 (FIG. 8) because the cutter blade 28 are prevented from coming into contact with the grass 50. As will be described later herein, cutter blades 28 may be converted to blower blades 52 to increase the quantity of air moving through cavity 28. FIGS. 2, 8 and 9 show that as three cutter blades 28/blower blades 52 rotate as indicated by arrows “C” in FIG. 9, air is pulled into cavity 12f from outside mower deck 12. The air is pulled into cavity 12f through opening 40 in the single duct version of retrofit-kit 18 or through the first opening, second opening and third opening in the three-vent version of retrofit-kit 118. The inflow of air into cavity 12f is indicated by arrows “D” in FIGS. 1, 2 and 8. The rotating blades 28, 52 direct the entrained air through cavity 12f and toward chute 12j. Each of the blades 28, 52 may be configured to rotate at different speeds. In particular, the blades 28, 52 may be arranged to rotate at different speeds in such a way that they tend to cause air moving through cavity 12f to accelerate from proximate the air intake (i.e., opening 40) to proximate the air outlet (i.e., chute 12j). As a result, the speed of the air exiting chute 12j in the direction of arrow “A” is faster than the speed of the air entering through opening 40 (or through first, second and third openings defined between retrofit-kit 118 and mower deck 12. In some instances air may be exhausted or discharged from the blower deck at speeds of about 200 miles per hour and at a rate of about 10000 cubic feet of air per minute.

Retrofit-kit 18 and retrofit-kit 118 may be described as bottom duct type blower decks as the air is sucked into the opening 40 or first, second and third openings between retrofit kit 118 and mower deck 12 proximate the flange 12b′ and lowermost portion 12b″ of the mower deck 12.

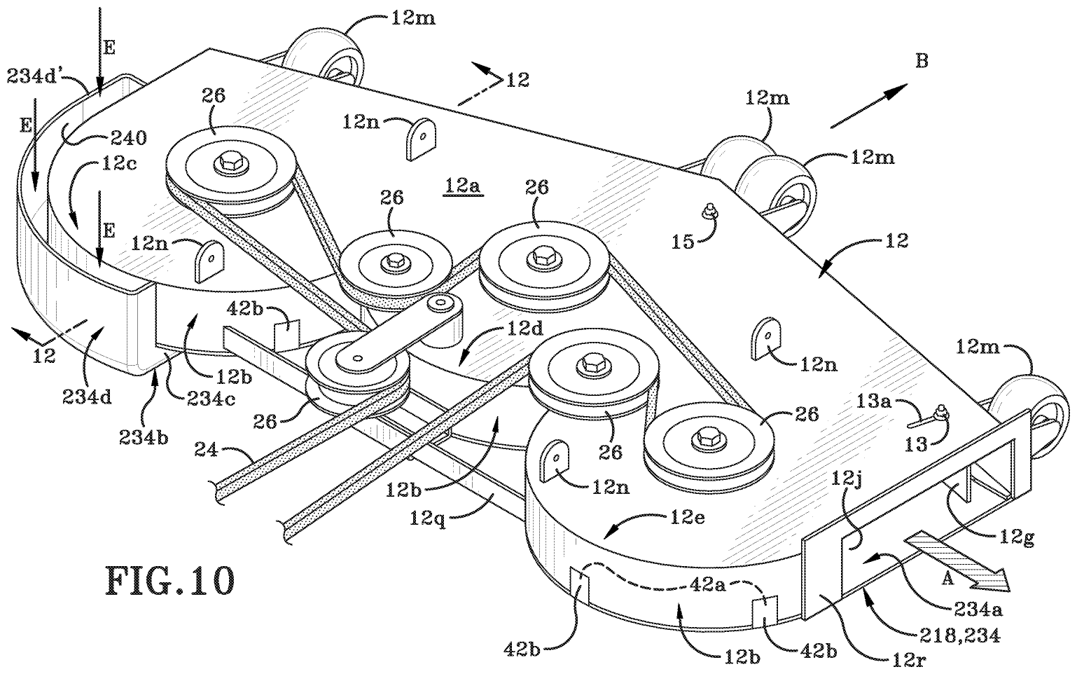

FIGS. 10-12 show another embodiment of retrofit-kit that may be selectively engaged with mower deck 12. This third embodiment of retrofit-kit is indicated by the reference number 218. Retrofit kit-218 comprises a comprising a first region 234a that is disposed in a first plane and a second region 234b that is recessed relative to first region 234a. Second region 234b is disposed in a second plane that may be substantially parallel to the first plane and is spaced a distance vertically below the first plane. Second region 234b is may be generally triangular in shape and may be formed in one corner of retrofit-kit 218 so that when retrofit-kit 218 is engaged with mower deck 12, second region 234b is located proximate first lobe 12c. Second region 234b is joined to first region 234a by transitional wall 234c. An arcuate side wall 234d extends upwardly from an outer perimeter of second region 234b opposite transitional wall 234c. Side wall 234d extends upwardly for a distance beyond first region 234a. Side wall 234d has an uppermost edge 234d′ that is locate a distance vertically above the plane in which first region 234a is disposed.

Retrofit-kit 218 has a peripheral edge 234e that extends around the perimeter of first region 234a and terminates in opposite portions of side wall 234d. Peripheral outer edge 234e is complementary to almost all of the flange 12b′ and lowermost edge 12b″ of the peripheral wall 12b of mower deck 12. When retrofit-kit 218 and mower deck 12 are engaged together, peripheral outer edge 234e aligns with flange 12b′ and lowermost edge 12b″ except in the region of side wall 234d. In the region of side wall 234d, the second region 234b extends for a distance laterally outwardly beyond peripheral wall 12b of mower deck 12. Side wall 234d is located laterally outwardly beyond that region of peripheral wall 12b and may be oriented substantially parallel thereto. As can be seen in FIG. 10, side wall 234d may be of a height that is sufficient that uppermost edge 234d′ thereof may be generally coplanar with first wall 12a of mower deck 12. An opening 240 is defined between side wall 234e and peripheral wall 12b of mower deck 12.

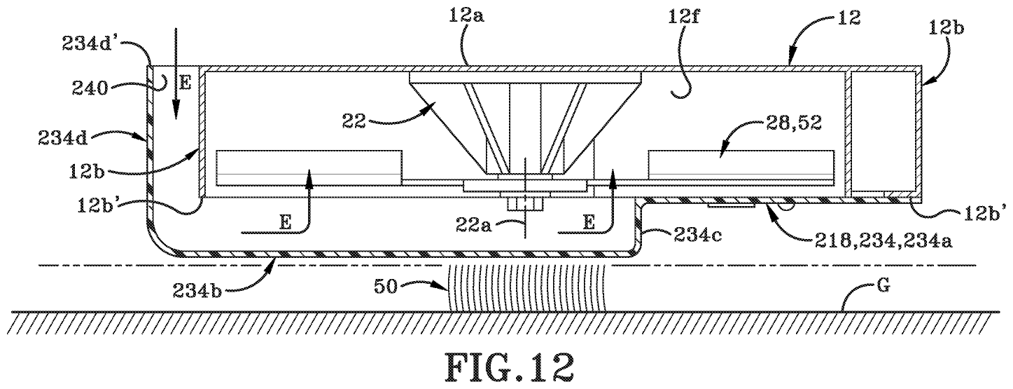

Base plate 234 of retrofit-kit 218 forms a bottom wall to cavity 12f defined by mower deck 12. Opening 240 is placed in fluid communication with cavity 12f. The opening to chute 12j is also placed in fluid communication with cavity 12f and thereby with opening 240. FIGS. 10 and 12 show that as blades 28, 52 rotate within cavity 12f, air is pulled from above mower deck 12 though opening 240 from outside the vehicle and into cavity 12f. The movement of air from outside the vehicle and into cavity 12f is indicated by arrows “E” (FIGS. 10 and 12). As is the case with retrofit-kits 18 and 118, the rotating blades 28, 52 accelerate the air as it flows from one side of mower deck 12 to the other and out of chute 12j.

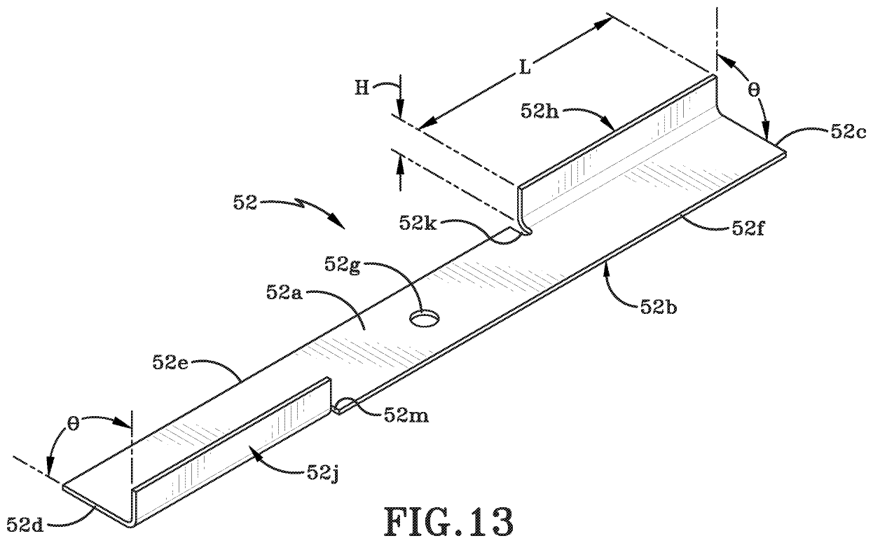

FIGS. 13-15 show blades that may be utilized as part of retrofit-kit 18, 118 or 218 or as part of deck 20. FIG. 13 shows a blower blade 52. Blower blade 52 comprises a plate that has a top surface 52a, a bottom surface 52b, a first end 52c, a second end 52d, a first side 52e, and a second side 52f. A central aperture 52g is defined in the plate and the aperture 52g extends from top surface 52a through to bottom surface 52b. The aperture 52g is configured to receive a bolt therethrough to secure blade 52 to mounting 22 on mower deck 12. In accordance with an aspect of the present disclosure, a pair of opposing fins 52h, 52j are each bent at an angle Ø relative to top surface 52a. Fin 52h extends upwardly from first side 52e and is separated therefrom by a slot 52k. Fin 52j extends upwardly from second side 52e and is separated therefrom by a sot 52m. The angle Ø can be anywhere from about 25 degrees up to about 90 degrees. Additionally, different blades 52 can have fins 52h that are of different lengths “L” and heights “H”, depending on the airflow they are designed to generate. Typically, the fins 52h and 52j may be of generally the same length “L” as each other and the same height “H” as each other. In other instances fin 52h may be of a different length and height to fin 52j. Blower blades 52 are provided to move air through cavity 20e. Blower blades 52 may be engaged with mower deck 12 after disengaging mower cutter blades therefrom.

FIG. 14 shows a cutter blade 28 that would typically be used on vehicle 10 to cut grass. The specific features illustrated on mower blade 28 may vary from one mower to another and are of no particular relevance to the present disclosure and therefore will not be described in any great detail herein. Suffice to say mower blade 28 includes a plate that has a top surface 28a, a bottom surface 28b, a first end 28c, a second end 28d, a first side 28e, and a second side 28f. A central aperture 28g is defined in the plate and aperture 28g extends from top surface 28a through to bottom surface 28b. Various cutting edges and flanges 28h are provided on first and second sides 28e, 28f.

In accordance with an aspect of the present disclosure, a pair of adapters 54 are selectively engageable with cutter blade 28. When a first adapter and a second adapter 54 are engaged with cutter blade 28, the cutter blade 28 is converted from a cutting implement to an air-blowing implement. Adapters 54 are substantially identical to each other. Each adapter 54 comprises a base having a first surface 54a, a second surface 54b, a first end 54c, a second end 54d, a first side 54e, and a second side 54f. A fin 54g extends upwardly from first side 54e and a C-shaped lip 54h extends downwardly from second side 54f. Fin 54g is oriented at an angle Ø relative to first surface 54a. Angle Ø may be anywhere from about 20° up to about 90°. A flange 54j extends outwardly from second end 54d. Flange 54j is substantially coplanar with the first and second surfaces 54a, 54b of the plate. An aperture 54k is defined in flange 54j and extends from first surface 54a through to second surface 54b. In accordance with a further aspect of the present disclosure, a pair of holes 28j is defined in cutter blade 28, with holes 28j being located on opposite sides of central aperture 28g and spaced a distance longitudinally away from central aperture 28g. Adapter 54 is free of cutting edges.

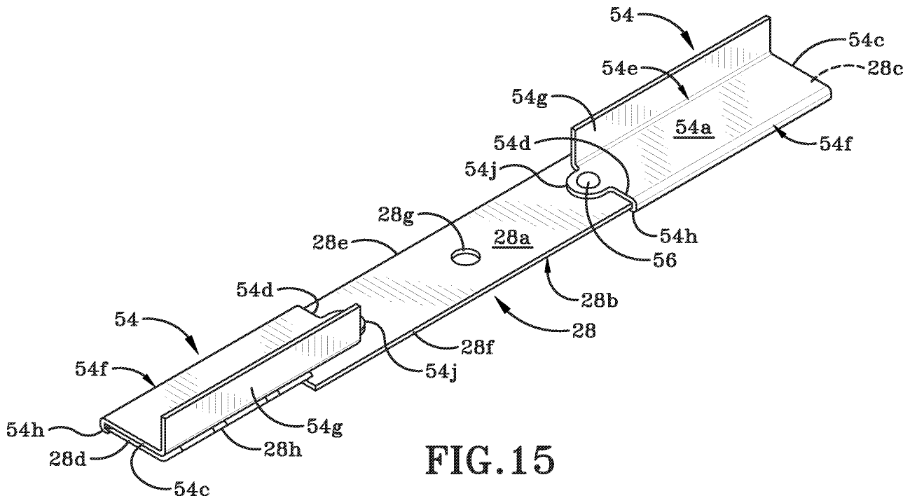

Each adapter 54 is configured to be secured to cutter blade 28 by placing second surface 54b of the adapter 54 on first surface 28a of cutter blade 28 and capturing a portion of the plate of cutter blade 28 within the C-shaped lip 54h (see FIG. 15). A bolt 56 is insertable through the aligned holes 54k, 28j and a nut 58 is threadably engaged with bolt 56 to keep adapter 54 secured to cutter blade 28. The combination of cutter blade 28 and two adapters 54 is substantially the equivalent of blower blade 52. As with blower blade 52 the length, height and angle 0 may be changed on adapter 54 to change the volume of air and the speed of the air generated by the rotation of combination blade 28/54.

FIG. 16, shows a mower deck 12 that has a blower deck secured beneath it by way of hook and loop fasteners or tabs and fasteners as described previously herein. By way of example, FIG. 16 shows hook and loop fasteners 42a, 42b. The blower deck in question will be one of the bottom duct retrofit-kits 18, 118. As illustrated in FIG. 1 as well, a deflector element 30 has been attached to mower deck 12 proximate chute 12j. In particular deflector element 30 is engaged in any suitable manner with chute frame 12r. Deflector element 30 may include a plurality of fins 30a that are operatively engaged with each other via a linkage 30b. Linkage 30b may be selectively moved to adjust the angle α of the fins 30a relative to linkage 30b so that fins 30a will point (or be angled) in a desired direction. As the angle α is changed, air flowing out of chute 12j will be channeled by fins 30a in the desired direction. The operator may change the position of linkage by depressing a button on a control console provided on vehicle 10 or in any other desired fashion. The orientation of fins 30a may be adjusted to direct yard debris, such as leaves 22 in FIG. 1 in a desired direction. The orientation of fins 30a may be adjusted as vehicle 10 travels across a lawn to direct yard debris 22 into a particular location on the ground surface. The position of linkage 30b may be locked so as to ensure a particular direction of air flowing out of deflector element 30. It will be understood that a deflector element 30 may similarly be engaged on a mower deck 12 that has retrofit-kit 218 engaged therewith.

FIG. 17 shows a mower deck 12 that has a blower deck secured beneath it by way of hook and loop fasteners or tabs and fasteners as described previously herein. By way of example only, FIG. 17 shows hook and loop fasteners 42a, 42b. The blower deck in question will be one of the bottom duct retrofit-kits 18, 118. A hose attachment 32 has been attached to mower deck 12 proximate chute 12j. In particular hose attachment 32 is engaged in any suitable manner with chute frame 12r. Hose attachment 32 may include a funnel region 32a and a hose 32b that extends outwardly from funnel region 32a. A nozzle 32c may be provided on the end of hose 32b. Hose 32b may be of any suitable length that will permit an operator to direct air in a desired direction. Obviously, it is likely most desirable to have vehicle stationary when using hose attachment 32.

FIGS. 18 to 24 show deck 20 in greater detail. As has been indicated earlier herein, deck 20 is designed to completely replace mower deck 12 on vehicle 10 (or even on vehicle 110 instead of being attached to attachment member 110a). In other words, deck 20 is configured to be under-body mounted on vehicle 10 or 110, preferably using exactly the same components as would mower deck 12 or 112.

The specific configuration (i.e., shape and size of deck 20 as illustrated in FIGS. 18-23 is designed to replace a mower deck that is configured exactly as shown in FIGS. 1-17. In other words, deck 20 is designed to replace a mower deck that has three cutter blades 28 for cutting grass and that further includes three lobes and can be operatively engaged with the various pulleys 26 and drive belt 24 that is illustrated on mower deck 12 in FIG. 2. Pulleys 26 are shown in FIG. 18 but drive belt 24 has been omitted therefrom for clarity of illustration only.

It should be understood however that deck 20 can be shaped in any fashion to replace any other differently configured mower deck on any type of landscaping vehicle and so the specific shape, size, length, height etc. of deck 20 should not be narrowly interpreted as being only as illustrated in FIGS. 18-23. Deck 20 includes a first wall 20a, a second wall 20b, and a side wall 20c extending between the first and second walls 20a, 20b. First wall 20a and side wall 20c are substantially identically configured to first wall 12a and peripheral wall 12b of mower deck 12. Second wall 20b is substantially identically configured to retrofit-kit 18. The description of mower deck 12 and retrofit-kit 18 should be understood to be fully describing first wall 20a, second wall 20b, and side wall 20c of deck 20. Deck 20 differs from the combination of mower deck 12 and retrofit-kit 18 in that the second wall 20b is permanently secured to side wall 20c instead of being detachably secured thereto by hook and loop fasteners or by tabs and fasteners. Instead, second wall 20b of deck 20 may be welded to side wall 20c. (In other instances, second wall 20b of deck 20 may be configured to snap-fittingly engage with side wall 20c. To this end, second wall 20b may be provided with a groove into which a bottom edge of side wall 20c may be interlockingly received or a portion of second wall 20b may curve upwardly and interlock with a portion of side wall 20c.)

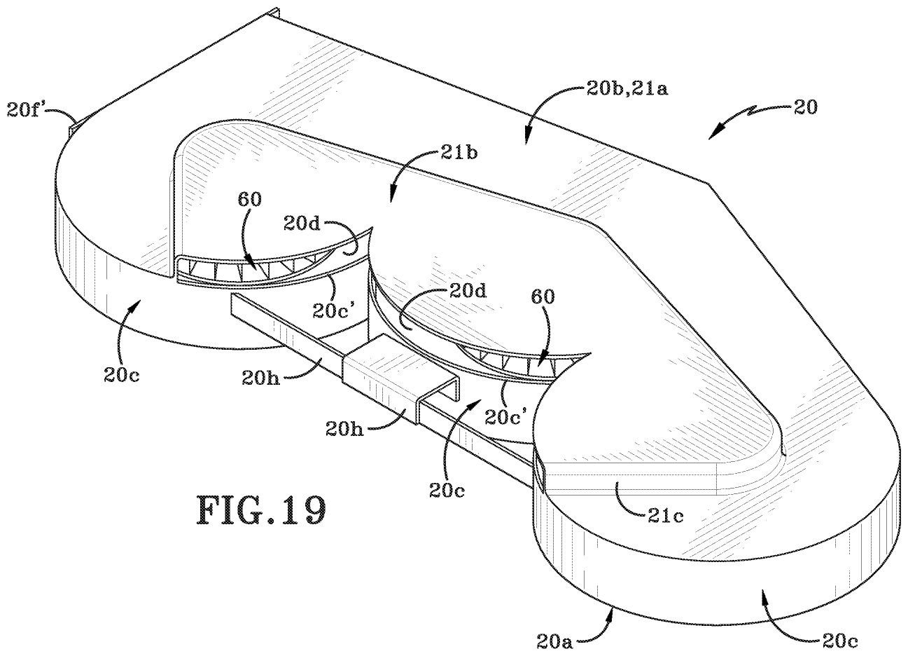

As shown in FIG. 19, second wall 20b may include a first region 21a and a second region 21b that are substantially identical in structure and function to first region 34a, and second region 34b, respectively. First region 21a and second region 21b may be joined by a transitional wall 21c that is substantially identical in structure and function to transitional wall 34c. An opening 20d is defined between a lowermost edge 20c′ of side wall 20c and second region 21b. First wall 20a, second wall 20b, and side wall 20c bound and define an interior cavity 20e. A chute 20f is defined in side wall 20c a distance away from opening 20d and is surrounded and strengthened by a chute frame 20f′. Both the opening 20d and chute 20f are in fluid communication with cavity 20e. A plurality of mounting brackets 20g are provided on first wall 20a and may be used to secure deck 20 to the frame of a vehicle 10 in a similar manner to the way mower deck 12 is secured to the frame. The same connector components that are used to secure mower deck 12 may be used to secure deck 20 to the vehicle frame. A support brace 20h may extend between lobes formed on deck 20 to stabilize and strengthen deck 20. (The lobes in deck 20 are substantially identical in structure and function to lobes 12c, 12d, 12e of mower deck 12.)

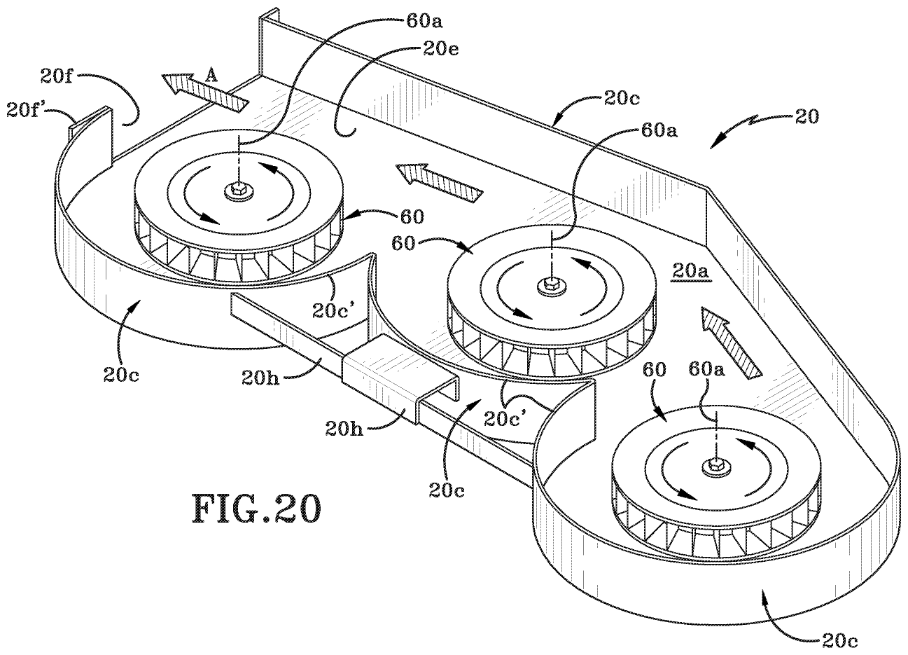

FIGS. 19 and 20 illustrate that instead of one or more blower blades 52 or cutter blades 28, a plurality of impellers 60 are mounted on the underside of first wall 20a. In particular, FIGS. 19 and 20 show three impellers 60 with each impeller 60 being mounted for rotation about a central axis 60a where the central axis 60a is provided by a bolt that secures the particular impeller 60 to first wall 20a. It will be noted that impellers 60 may be caused to rotate at different speeds or variable speeds in order to accelerate air through cavity 20e. Impellers 60 may be multiple-stage impellers that are operable to draw air into the cavity 20e, and to accelerate air in cavity 20e toward the air outlet.

Deck 20 as shown in FIGS. 18-20 is used in a similar manner to mower deck 12 in combination with retrofit-kit 18. Impellers 60 will rotate about their central axes 60a and will draw air into the cavity 20e through opening 20d. The air flowing into cavity 20e may be accelerated by impellers 60 and pass out of cavity 20e through chute 20f. Deflector element 30 or hose attachment 32 may be selectively engaged with deck 20 as previously described with respect to mower deck 12 in combination with retrofit-kit 18. Air discharged out of chute 20f is indicated by arrows “A” in FIG. 20.

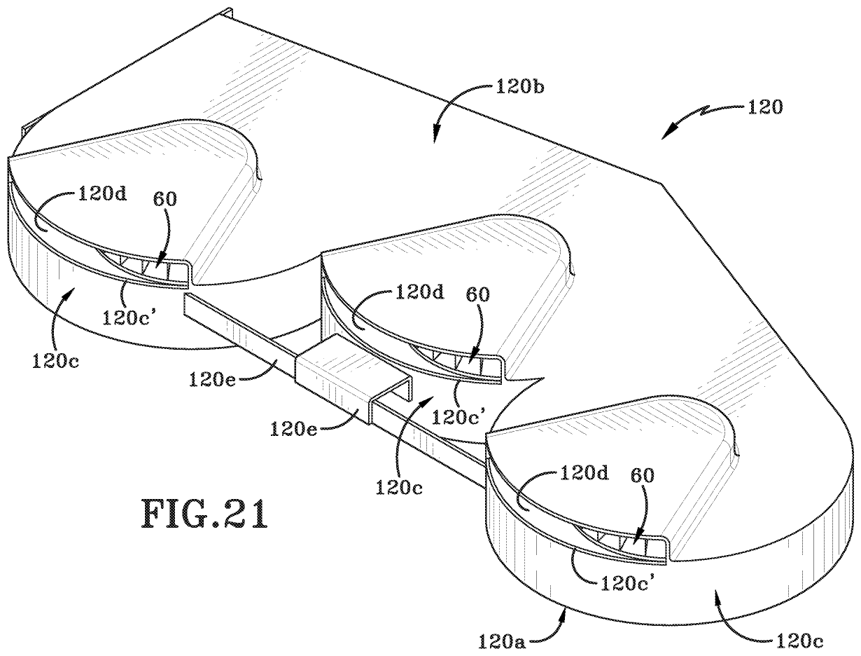

FIG. 21 shows an alternative embodiment of an independent blower deck, indicated generally by the reference number 120. Deck 120 is substantially identical in structure and function to mower deck 12 in combination with retrofit kit 118. Deck 120 includes a first wall 120a, a second wall 120b, and a side wall 120c extending between first wall 120a and second wall 120b and welded thereto. First wall 120a and side wall 120c are substantially identical in structure and function to first wall 12a and peripheral wall 12b of mower deck 12. Second wall 120b is substantially identical in structure and function to retrofit kit 118. Consequently, three openings 120d are defined between second wall 120b and a lowermost edge 120c′ of side wall 120c. Air is able to be pulled into the interior cavity of deck 120, where that interior cavity is bounded and defined by first wall 120a, second wall 120b, and side wall 120c. As with deck 20, a chute is defined in side wall 120c and is surrounded by a chute frame. The chute and chute frame are substantially identical to chute 20f and chute frame 20f′. A bracing member 120e extends between two lobes provided on deck 120. (As with deck 20, the lobes on deck 120 are substantially identical in structure and function to lobes 12c, 12d, and 12e on mower deck 12.) When impellers 60 are rotated then air is drawn into the interior cavity of deck 120 through the three openings 12d, and is pushed out through the chute. A deflector element 30 and hose attachment 32 may be selectively engaged with deck 120 as has been previously described herein with respect to mower deck and retrofit-kit 18.

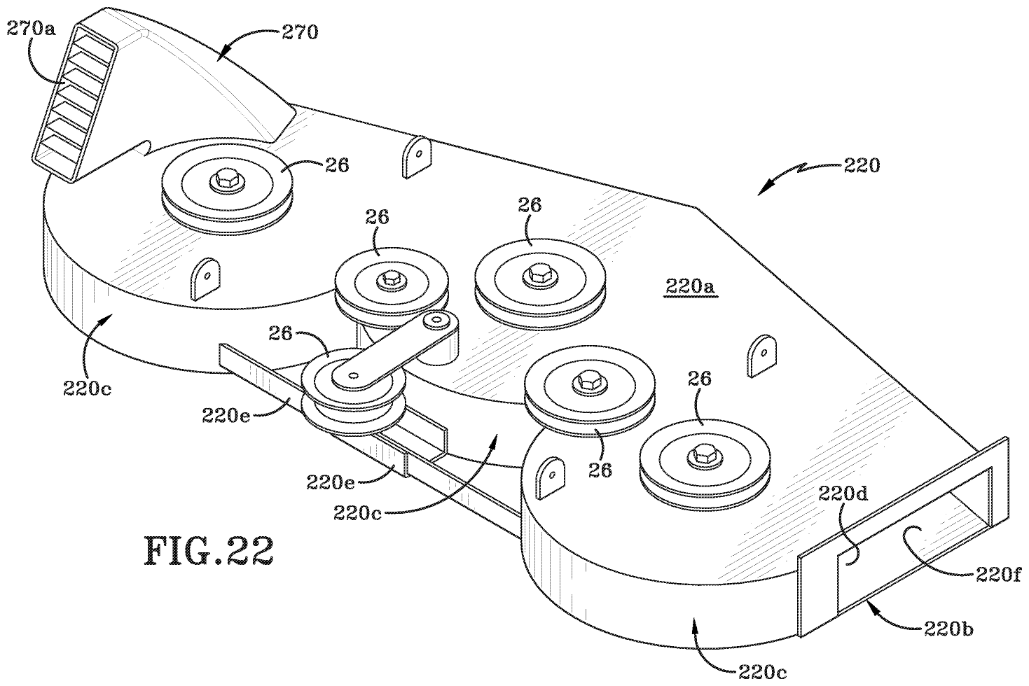

FIG. 22 shows a third embodiment of an independent blower deck, generally indicated by the reference number 220. Deck 220 comprises a first wall 220a, a second wall 220b, and a side wall 220c that extends between first and second walls 220a, 220b and is welded thereto. In this particular instance, second wall 220b is simply a flat plate that is substantially identical in profile to side wall 220c except that second wall 20b extends across the U-shaped opening defined in side wall 220c that ultimately forms chute 220d. A brace 220e extends between lobes formed in deck 220. As with the previous decks 20, 120, the lobes are substantially identical to lobes 12c, 12d, and 12e in mower deck 12. First wall 220a differs from first wall 20a and 120a in that an opening is defined therein and an inlet assembly 270 extends upwardly and outwardly from first wall 20a. Inlet assembly 270 defines an opening 270a therein that is in fluid communication with an interior cavity 220f. Fins 270b may extend across opening 270a to ensure that yard debris does not easily enter interior cavity 220f through opening 270a. Interior cavity 220f is bounded and defined by first wall 220a, second wall 220b, and side wall 220c. All other components on deck 220 are substantially identical to decks 20 or 120 and deck 220 is engaged in an under-body orientation in a substantially identical manner as to how mower deck 12 or decks 20 or 120 are engaged with the vehicle frame. (It should be understood that in any of decks 20, 120 and 220, blower blades 52 or cutter blades 28 with adapters 54 may be utilized instead of impellers 60.)

In use, air is drawn from outside vehicle 10 through opening 270a when impellers 60 (or blades 52 or 28, 54) are rotated. The impellers 60 accelerate the air flowing through cavity 220f and expel that air through chute 220d. As with the previous decks 20, 120, deflector element 30 or hose attachment 32 may be engaged with deck 220.

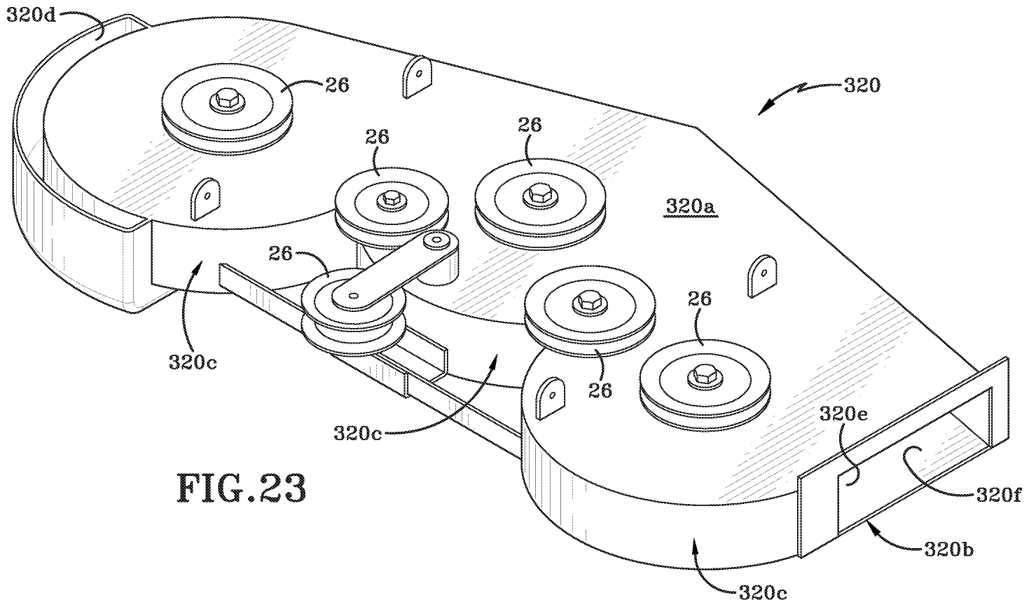

FIG. 23 shows a further embodiment of an independent blower deck in accordance with an aspect of the present invention, generally indicated at 320. Deck 320 is substantially identical to mower deck 12 in combination with retrofit-kit 218. Deck 320 includes a first wall 320a, a second wall 320b, and a side wall 320c extending between first and second walls 320a, 320b and welded thereto. First wall 320a and side wall 320c are substantially identical in structure and function to first wall 12a and peripheral wall 12b. Second wall 320b is substantially identical to retrofit-kit 218. Consequently, a duct opening 320d is defined between a portion of second wall 320b and a portion of side wall 320c. A chute 320e is defined in an opposing region of side wall 320c. duct opening 320d and chute 320e are in fluid communication with an interior cavity 320f defined by first wall 320a, second wall 320b and side wall 320c. Impellers 60 or blower blades 58 or cutter blades 28 with adapters 54 are mounted for rotation within interior cavity 320f as has been previously described herein. When the impellers 60 of blades 58, 28/54 are rotated, air is drawn into interior cavity 320f through opening 320d and is expelled at velocity though chute 320e. As with previous embodiments, a deflector element 30 or hose attachment 32 may be engaged with deck 320. It will be understood that all other components on deck 320 are substantially identical in structure and function to those provided on mower deck 12 with associated retrofit-kits 18, 118, 218 or decks 20, 120, 220.

FIG. 24 shows an independent blower deck 20, 120, 220, or 320 engaged with an attachment member 110a as has been previously described herein.

It should be understood that while the blower deck 20 has been disclosed herein as replacing a mower deck on a landscaping vehicle, blower deck 20 may instead replace any other type of attachment for performing a landscaping task on the landscaping vehicle provided that the rotatable members (i.e., the blades or impellers) of the blower deck 20 are able to be operatively connected to the motor of the vehicle in order to be driven thereby. During operation of the blower deck or the retrofit kit, the method includes operatively engaging the one or more rotatable members (cutter blade with actuators, blower blade, or impeller) with a drive mechanism of the landscaping vehicle; and actuating the drive mechanism to rotate the one or more rotatable members. The drive mechanism may include the motor 27 (FIG. 1) and the pulleys 26 and belts 24 shown in FIG. 2.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. In combination:
a vehicle having a body and a plurality of wheels for moving the body across a surface; and
a blower deck; wherein the blower deck comprises:
a first wall adapted to be engaged with a frame of the vehicle;
a second wall spaced a distance from the first wall;
a side wall extending between the first and second walls;
a cavity bounded and defined by the first wall, the second wall,
and the side wall;
at least one rotatable member extending from the first wall into the cavity;
an air intake defined in one of the first wall, the second wall or the side wall; and
an air outlet defined in one of the first wall, the second wall, or the side wall a spaced distance from the air intake; and wherein the blower deck is located horizontally underneath a portion of a body of the vehicle.

2. The combination as defined in claim 1, wherein the vehicle is a zero-turn vehicle.

3. The combination as defined in claim 1, wherein the vehicle is a mower.

4. The combination as defined in claim 1, wherein the vehicle is a stand-on mower.

5. The combination as defined in claim 1, wherein the vehicle is a ride-on mower.

6. The combination as defined in claim 1, wherein the vehicle is a walk-behind mower.

7. The combination as defined in claim 1, wherein the vehicle is a mower and includes a mower deck; and wherein the first wall of the blower deck is an upper wall of the mower deck; wherein the side wall of the blower deck is a peripheral wall of the mower deck that extends downwardly from the upper wall; and wherein the at least one rotatable member of the blower deck is at least one cutter blade of the mower.

8. The combination as defined in claim 7, further comprising at least one adapter selectively engageable with the at least one cutter blade; wherein the at least one adapter converts the at least one cutter blade to at least one blower blade.

9. The combination as defined in claim 8, wherein the at least one adapter includes a base that is securable to the at least one cutter blade and a flange that extends outwardly from the base at an angle.

10. The combination as defined in claim 9, wherein the angle of the flange relative to the base is from about 25 degrees up to about 90 degrees.

11. The combination as defined in claim 8, wherein the least one adapter is free of any cutting edges.

12. The combination as defined in claim 8, wherein the at least one adapter comprises a first adapter and a second adapter; and the first adapter is engaged at a first end of the at least one cutter blade and the second adapter is engaged at a second end of the at least one cutter blade.

13. The combination as defined in claim 7, wherein the at least one rotatable member comprises three cutter blades; and the three cutter blades are spaced at intervals from each other.

14. The combination as defined in claim 7, wherein the at least one rotatable member is an impeller that is engaged with the mower deck in place of the at least one cutter blade.

15. The combination as defined in claim 7, wherein the at least one rotatable member comprises three impellers that are engaged with the mower deck in place of the at least one cutter blade and the three impellers are spaced at intervals from each other.

16. The combination as defined in claim 1, wherein the air intake comprises a single duct.

17. The combination as defined in claim 1, wherein the air intake comprises multiple ducts and the multiple ducts are spaced at intervals from each other.

18. The combination as defined in claim 1, wherein the air intake is located between a bottom edge of the side wall and the second wall.

19. The combination as defined in claim 1, wherein the air outlet is located in the side wall.

20. The combination as defined in claim 1, wherein the side wall is welded to each of the first wall and the second wall.

21. The combination as defined in claim 1, wherein the second wall of the blower deck is a separate base plate that is securable to the side wall with at least one fastener assembly.
